(19) United States
(12) Patent Application Publication
(10) Pub. No.: US 2007/0189337 A1
(43) Pub. Date: Aug. 16, 2007

(54) Next generation network system based on TCM ISDN technique and control method thereof

(76) Inventor: Yong-Ki Kim, Suwon-si (KR)

Correspondence Address: Robert E. Bushnell, Suite 300, 1522 K Street, N.W., Washington, DC, 20005-1202, US

(21) Appl. No.: 11/642,878

(22) Filed: Dec. 21, 2006

(30) Foreign Application Priority Data
Feb. 10, 2006 (KR) 10-2006-0013300

(51) Int. Cl. H04J 3/12

(52) U.S. Cl. 370/524

(57) ABSTRACT

A next generation network system based on a time compression multiplex integrated service digital network technique (TCM ISDN) and a control method thereof. The system includes a synchronous clock generator for generating a transmit timing reference (TTR) reference clock to be used in a TCM ISDN and an xDSL, using a broadband clock provided through an asynchronous transfer mode (ATM) network; and a TCM ISDN subscriber processor for temporarily storing TCM ISDN data received from a public switched telephone network (PSTN), arranging a frame of the TCM ISDN data, synchronizing the TCM ISDN data to the TTR reference clock provided from the synchronous clock generator, and transmitting the synchronized TCM ISDN data to a TCM ISDN subscriber while, synchronizing the TCM ISDN data received from a TCM ISDN terminal, to the TTR reference clock input from the synchronous clock generator, temporarily storing the synchronized TCM ISDN data, and transmitting the stored TCM ISDN data to the PSTN.

### CLAIM OF PRIORITY

This application makes reference to, incorporates the same herein, and claims all benefits accruing under 35 U.S.C.§119 from an application for NEXT GENERATION NETWORK AND CONTROL METHOD TO APPLY TIME COMPRESSION MULTIPLEX INTEGRATED SER VICE DIGITAL NETWORK FUNCTION earlier filed in the Korean Intellectual Property Office on 10 Feb. 2006 and there duly assigned Serial No. 10-2006-0013300.

### BACKGROUND OF THE INVENTION

1. Field of the Invention

The present invention relates to technology for voice and data service transmission of a time compression multiplex (TCM) integrated service digital network (ISDN) digital subscriber using a TCM line transmission method in a next generation network (NGN).

2. Description of the Related Art

In general, a next generation network communication system refers to a system in which an ISDN service using a public switched telephone network (PSTN) and an asymmetric digital subscriber line (ADSL) service using an asynchronous transfer mode (ATM) network are integrated.

In the ISDN service, the PSTN and a subscriber terminal are connected through an exchange in-house TCM ISDN subscriber matching device and an E1 trunk (V5.2) line. Upon receipt of TCM ISDN data (voice and data) from the PSTN, the TCM ISDN subscriber matching device transmits the received TCM ISDN data to a TCM ISDN terminal (e.g., a telephone, a personal computer (PC), and a personal digital assistant (PDA)) while, upon receipt of TCM ISDN data (voice and data) from the TCM ISDN terminal, transmits the received TCM ISDN data to the PSTN. The TCM ISDN data transmitted/received using the PSTN service is based on a narrowband clock (8 KHz or 2.048 KHz) provided from the PSTN. In other words, in the TCM ISDN subscriber matching device, the narrowband clock provided from the PSTN is used as it is.

In the ADSL service, the ATM network and an xDSL terminal (e.g., a PC and a notebook computer) connect through an MDSLAM (multi-Digital Subscriber Line Access Multiplexer) or a DSLAM (Digital Subscriber Line Access Multiplexer) having at least one xDSL (VDSL, ADSL, and SHDSL) subscriber service unit within an apartment complex, and an xDSL dedicate line. Upon receipt of xDSL data from the ATM network, the MDSLAM transmits the received xDSL data to the xDSL terminal while, upon receipt of xDSL data from the xDSL terminal, transmits the received xDSL data to the ATM network. The xDSL data transmitted/received using the ADSL service is based on a broadband clock (64 KHz) provided from the ATM network.

As described above, the next generation network system is an integration of the ADSL service and the ISDN service and therefore, an E1 trunk (V5.2) line of an ISDN and an xDSL dedicate line of an ADSL are bundled and used as one line.

In other words, in the next generation network system in which the E1 trunk (V5.2) line of the ISDN and the xDSL dedicate line of the ADSL are used as one bundle line, when the data transmitted/received using the ADSL service and the ISDN service is not in synchronization, mutual interference noise, such as a near end x-talk (NEXT) and a far end x-talk (FEXT) of the digital subscriber, is caused.

In order to overcome the above drawback, TCM ISDN technology is being used. The TCM ISDN technology is standardized in “Specific requirements for an ADSL system operating in the same cable as TCM ISDN as defined in ITU-T Recommendation G.961 Appendix III” of ITU-T G.992.1 Annex-C among technologies of an asymmetric digital subscriber line (ADSL) popularized in recent years.

The TCM ISDN technology uses the xDSL dedicate line and the ISDN subscriber line as one bundle cable and therefore, the data is transmitted/received in synchronization with a specific clock (400 Hz). In order to apply the TCM ISDN technology to the next generation network system, a synchronization system for data synchronization is required.

Accordingly, the next generation network system based on the TCM ISDN technology provides a DCS (digital clock supply) clock providing device in an exchange office, and receives a narrowband TTR reference clock provided from the PSTN and provides the received narrowband TTR reference clock (400 Hz) to the TCM ISDN subscriber matching device and the MDSLAM. The DCS clock providing device has an AMI signal having a cycle frequency of 64 KHz, and transmits the AMI signal to the TCM ISDN matching device and the MDSLAM.

However, in the next generation network system based on the TCM ISDN technology, the TCM ISDN subscriber matching device of the exchange office that should perform synchronization using the TTR reference clock is provided distant away from the remote MDSLAM. Therefore, signal transmission is delayed depending on a distance or a connection method and thus, there occurs error at a start frequency position of a 400 Hz+offset value that represents a transmission reference of a TTR signal of the TCM ISDN. In other words, due to offset inaccuracy, in the bundle cable of the ADSL and the TCM ISDN, FEXT (far-end crosstalk) and NEXT (near-end crosstalk) noises cause error of transmission/reception data.

Depending on a synchronization hierarchy of the DCS clock providing device, a network timing reference (NTR) phase can be enabled differently from that of a switching network.

A start point of 400 Hz should start in synchronization with a specific one of 8 KHz of twenty NTRs associated with the switching network, but the NTR changes depending on a phase locked loop (PLL) hierarchy of the DCS clock providing device.

Accordingly, it is impossible to hold the TCM ISDN and ADSL subscribers within the same system, using only the technology.

This is because, in case where the ISDN subscriber line and the xDSL line are constructed, using the bundle cable, between the TCM ISDN subscriber matching device that is provided within a narrowband network holding equipment of the PSTN and the MDSLAM that is a broadband network housing equipment of the ATM network, a line noise is caused and a service cannot be provided.

The TCM ISDN subscriber matching device and the MDSLAM that has at least one xDSL (VDSL, ADSL, and SHDSL) subscriber service unit are provided a distance away. Therefore, the DCS clock providing devices are provided, respectively, and the same synchronous clock is received 3 from the satellite system and provided to the TCM ISDN subscriber matching device and the MDSLAM, respectively, thereby solving the drawback.

However, in case where the satellite system is used as above, there is a drawback in that the next generation network system additionally necessarily should include the satellite system.

To provide the xDSL and TCM ISDN services to the xDSL subscriber through integration/construction on the same line as that for the TCM ISDN service using the ATM network, a signal generator is provided in a separate ATM network, and generates a 400 Hz signal and a TTR clock signal for eliminating the NEXT and FEXT noises with the xDSL subscriber from exchange in-house equipment and a DSLAM equipment of the ATM network, and uses the generated signals as signals synchronized to the PSTN. In other words, only a TCM ISDN voice and data service has been made possible as the service using the narrowband network.

With the advent of a next generation network (NGN) for concurrently providing the xDSL subscriber service based on the ATM network and the TCM ISDN subscriber service based on the PSTN in a recent NGN (next generation network) equipment, the above equipments are held in different types from that the xDSL subscriber, and the TCM ISDN subscriber are held within the same system and provided with the service. In the case of concurrently holding the xDSL and the TCM ISDN of an Access GateWay (AGW), the service is impossible.

### SUMMARY OF THE INVENTION

It is an objective of the present invention to provide a next generation network system based on a TCM ISDN technique and a control method thereof, for controlling near end x-talk (NEXT) and far end x-talk (FEXT) noises that are caused by integration of an ISDN subscriber line of a TCM ISDN service and an xDSL dedicate line of an xDSL service.

A first aspect of the present invention provides a next generation network system based on a time compression multiplex (TCM) integrated service digital network (ISDN) technique. The system comprises: a synchronous clock generator for generating a transmit timing reference (TTR) reference clock to be used in a TCM ISDN and an xDSL, using a broadband clock provided through an asynchronous transfer mode (ATM) network; and a TCM ISDN subscriber processor for temporarily storing TCM ISDN data received from a public switched telephone network (PSTN), arranging a frame of the TCM ISDN data, synchronizing the TCM ISDN data to the TTR reference clock provided from the synchronous clock generator, and transmitting the synchronized TCM ISDN data to a TCM ISDN subscriber while, synchronizing TCM ISDN data received from a TCM ISDN terminal, to the TTR reference clock input from the synchronous clock generator, temporarily storing the synchronized TCM ISDN data, and transmitting the stored TCM ISDN data to the PSTN.

The synchronous clock generator may comprise a clock processor for generating an xDSL data synchronous clock and a TTR reference clock, using the broadband clock provided from the ATM network; and a phase locked loop for providing a TCM ISDN data clock to the TCM ISDN subscriber processor, using the xDSL data synchronous clock and the TTR reference clock provided from the clock processor and a divided clock provided from an oscillator.

The broadband clock received from the ATM network may be a DCS clock of 64 KHz, and the TCM ISDN data clock provided from the phase locked loop may be a clock of 2.049 KHz.

The TCM ISDN subscriber processor may comprise a transmission storage unit for temporarily storing the TCM ISDN data input from the PSTN; a reception storage unit for temporarily storing the TCM ISDN data received from the TCM ISDN terminal; and a frame arrangement unit for, upon receipt of the TCM ISDN data from the PSTN, temporarily storing the received TCM ISDN data in the transmission storage unit, synchronizing the stored TCM ISDN data to the TTR reference clock provided from the synchronous clock generator, and transmitting the synchronized TCM ISDN data to the TCM ISDN subscriber while, upon receipt of the TCM ISDN data from the TCM ISDN terminal, synchronizing the received TCM ISDN data to the TTR reference clock provided from the synchronous clock generator, temporarily storing the synchronized TCM ISDN data, and transmitting the stored TCM ISDN data to the PSTN.

The transmission storage unit may have a capacity of 128 bytes, and comprise three storage areas in a unit of 32 bytes. In other words, the capacity of the transmission storage unit uses an address of 128 bytes. Since the ISDN data (E1 data) of the PSTN 1 has a transfer rate of 2048 Kbps at a cycle (125 msec) of 8 KHz, it is stored in the unit of 32 bytes on the basis of its capacity of 32 bytes.

The transmission storage unit may comprise an ISDN transmission data input area for storing the input data; and an ISDN transmission data output area for outputting the stored data. The transmission storage unit may further comprise an ISDN transmission data moving area for moving the data from the ISDN transmission data input area to the ISDN transmission data output area.

The reception storage unit may have a capacity of 128 bytes, and comprise three storage areas in a unit of 32 bytes. The reception storage unit may comprise an ISDN reception data input area for storing the input data; and an ISDN reception data output area for outputting the stored data. The reception storage unit may further comprise an ISDN reception data moving area for moving the data from the ISDN reception data input area to the ISDN reception data output area.

A second aspect of the present invention provides a next generation network system control method based on a TCM (time compression multiplex) ISDN (integrated service digital network) technique. The method comprises the steps of: in a synchronous clock generator, generating a TTR (transmit timing reference) reference clock and an xDSL data synchronous clock, using a broadband clock provided from an ATM (asynchronous transfer mode) network; and in a TCM ISDN subscriber processor, upon receipt of TCM ISDN data from a PSTN (public switched telephone network), temporarily storing the received TCM ISDN data, synchronizing the stored TCM ISDN data to the TTR reference clock and the xDSL data synchronous clock, and transmitting the synchronized TCM ISDN data to a TCM ISDN subscriber.

The step of generating the TTR reference clock and the xDSL data synchronous clock, using the broadband clock provided from the ATM network, may comprise the steps of: receiving the broadband clock from the ATM network; generating the xDSL data synchronous clock and the TTR reference clock, using the received broadband clock; and generating a TCM ISDN data clock using the generated xDSL data synchronous clock and TTR reference clock and a divided clock provided from an oscillator, and providing the generated TCM ISDN data clock to the TCM ISDN subscriber processor. The TCM ISDN data clock is a clock of 2.049 KHz.

The step of, upon receipt of the TCM ISDN data from the PSTN, temporarily storing the received TCM ISDN data, synchronizing the stored TCM ISDN data to the TTR reference clock and the xDSL data synchronous clock, and transmitting the synchronized TCM ISDN data to the TCM ISDN subscriber, may comprise the steps of: storing the TCM ISDN data received from the PSTN, in an ISDN transmission data input area; and synchronizing the TCM ISDN data stored in an ISDN transmission data output area, to the TTR reference clock, and transmitting the synchronized TCM ISDN data to a TCM ISDN terminal.

In the step of, upon receipt of the TCM ISDN data from the PSTN, temporarily storing the received TCM ISDN data, synchronizing the stored TCM ISDN data to the TTR reference clock and the xDSL data synchronous clock, and transmitting the synchronized TCM ISDN data to the TCM ISDN subscriber, after the TCM ISDN data is transmitted in synchronization with the TTR reference clock, the TCM ISDN data stored in each area may be shifted and moved to a next area.

The method may further comprises the step of, upon receipt of the TCM ISDN data from a TCM ISDN terminal, synchronizing the received TCM ISDN data to the TTR reference clock and the xDSL data synchronous clock, temporarily storing the synchronized TCM ISDN data, and transmitting the stored TCM ISDN data to the PSTN.

The step of, upon receipt of the TCM ISDN data from the TCM ISDN terminal, synchronizing the received TCM ISDN data to the TTR reference clock and the xDSL data synchronous clock, temporarily storing the synchronized TCM ISDN data, and transmitting the stored TCM ISDN data to the PSTN, may comprise the steps of: synchronizing the TCM ISDN data received from the TCM ISDN terminal, to the TTR reference clock, and storing the synchronized TCM ISDN data in an ISDN reception data input area; and transmitting the TCM ISDN data stored in an ISDN reception data output area, to the PSTN.

In the step of, upon receipt of the TCM ISDN data from the TCM ISDN terminal, synchronizing the received TCM ISDN data to the TTR reference clock and the xDSL data synchronous clock, temporarily storing the synchronized TCM ISDN data, and transmitting the stored TCM ISDN data to the PSTN, after transmitting the TCM ISDN data stored in synchronization with the TTR reference clock, to the PSTN, the TCM ISDN subscriber processor may shift and move the TCM ISDN data stored in each area, to a next area.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a functional block diagram illustrating the construction of a next generation network system based on a TCM ISDN technique according to the present invention;

FIG. 2A is a functional block diagram illustrating the detailed construction of a reception storage unit in the next generation network system based on the TCM ISDN technique of FIG. 1;

FIG. 2B is a functional block diagram illustrating the detailed construction of a transmission storage unit in the next generation network system based on the TCM ISDN technique of FIG. 1;

FIG. 2C is an illustration of inputs and outputs of the transmission/reception storage unit of FIGS. 2A and 2B;

FIG. 3 is a flowchart illustrating a next generation network system control method based on a TCM ISDN technique according to the present invention;

FIG. 4 is a flowchart illustrating in detail the step (S1) of, in a synchronous clock generator, generating and providing a TTR reference clock and an xDSL data synchronous clock using a broadband clock in the next generation network system control method based on the TCM ISDN technique of FIG. 3;

FIG. 5 is a flowchart illustrating in detail the step (S2) of, in a TCM ISDN subscriber processor, temporarily storing ISDN data received from a PSTN, synchronizing the stored ISDN data to a TTR reference clock and an xDSL data synchronous clock, and transmitting the synchronized data to a TCM ISDN terminal in the next generation network system control method based on the TCM ISDN technique of FIG. 3; and

FIG. 6 is a flowchart illustrating in detail the step (S3) of, in a TCM ISDN subscriber processor, synchronizing ISDN data received from a TCM ISDN terminal, to a TTR reference clock and an xDSL data synchronous clock, temporarily storing the synchronized ISDN data, and transmitting the stored ISDN data to a PSTN.

### DETAILED DESCRIPTION OF EXEMPLARY EMBODIMENTS

Hereinafter, exemplary embodiments of the present invention will be described in detail with reference to the accompanying drawings. In the following description, a detailed description of known functions and configurations incorporated herein has been omitted for conciseness.

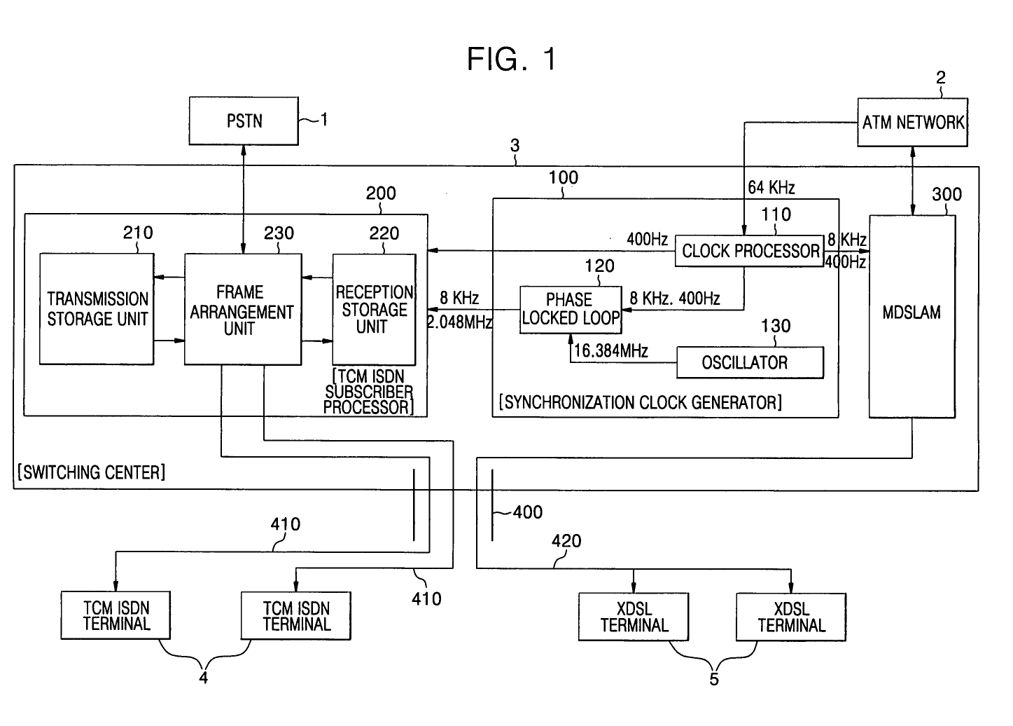

FIG. 1 is a functional block diagram illustrating the construction of a next generation network system based on a time compression multiplex (TCM) integrated service digital network (ISDN) technique according to the present invention. The inventive next generation network system based on the TCM ISDN technique includes a synchronous clock generator 100, a TCM ISDN subscriber processor 200, an MDSLAM 300, and a bundle line 400 in which an ISDN subscriber line 410 (connected to TCM ISDN terminals 4) and an x digital subscriber line (xDSL) dedicate line 420 (connected to xDSL terminals 5) are bundled as one line. The TCM ISDN subscriber processor 200 temporarily stores TCM ISDN data received from a public switched telephone network (PSTN) 1.

The synchronous clock generator 100 generates a transmit timing reference (TTR) reference clock (400 Hz) to be used in a TCM ISDN and an xDSL, using a broadband clock (64 KHz) provided from an asynchronous transfer mode (ATM) network 2, and supplies the generated TTR reference clock to each of the TCM ISDN subscriber processor 200 and the MDSLAM 300. The synchronous clock generator 100 includes a clock processor 110 and a phase locked loop 120.

The clock processor 110 of the synchronous clock generator 100 generates an xDSL data synchronous clock (8 KHz) for synchronizing xDSL data using the broadband clock (64 KHz) provided from the ATM network 2 and generates the TTR reference clock (400 Hz), respectively, and provides the generated clocks to the MDSLAM 300 and the phase locked loop 120 and at the same time, provides the TTR reference clock (400 Hz) to the TCM ISDN subscriber processor 200.

The phase locked loop 120 of the synchronous clock generator 100 generates a TCM ISDN data clock (2.048 KHz) using the xDSL data synchronous clock (8 KHz) and the TTR reference clock (400 Hz) received through the clock processor 110 and a divided clock (16.384 MHz) provided from an oscillator 130, and provides the generated TCM ISDN data clock (2.048 KHz) and the xDSL data synchronous clock (8 KHz) to the TCM ISDN subscriber processor 200.

The TCM ISDN subscriber processor 200 temporarily stores TCM ISDN data received from a public switched telephone network (PSTN) 1, arranges frames of the TCM ISDN data, synchronizes the TCM ISDN data to the TCM ISDN data clock (2.048 KHz) and the TTR reference clock (400 Hz) that are provided through the synchronous clock generator 100, and transmits/receives the TCM ISDN data to/from a TCM ISDN subscriber.

Meanwhile, the TCM ISDN subscriber processor 200 receives TCM ISDN data from a TCM ISDN terminal 4, and synchronizes the received TCM ISDN data to the TCM ISDN data clock (2.048 KHz) and the TTR reference clock (400 Hz) that are provided from the synchronous clock generator 100, and temporarily stores and transmits the synchronized TCM ISDN data to the PSTN 1.

The TCM ISDN subscriber processor 200 includes a transmission storage unit 210, a reception storage unit 220, and a frame arrangement unit 230. The TCM ISDN subscriber processor 200 also includes, but not shown, an E1 line interface, a TCM ISDN digital front end unit and an analog front end unit.

Since the TCM ISDN subscriber processor 200 does not receive a synchronous clock from the PSTN 1, it receives the TCM ISDN data synchronous clock (2.048 MHz) necessary for ISDN data transmission, through the synchronous clock generator 100.

The transmission storage unit 210 of the TCM ISDN subscriber processor 200 temporarily stores the TCM ISDN data input through the PSTN 1. The transmission storage unit 210 has a capacity of 128 bytes, and has three storage areas set in a unit of 32 bytes.

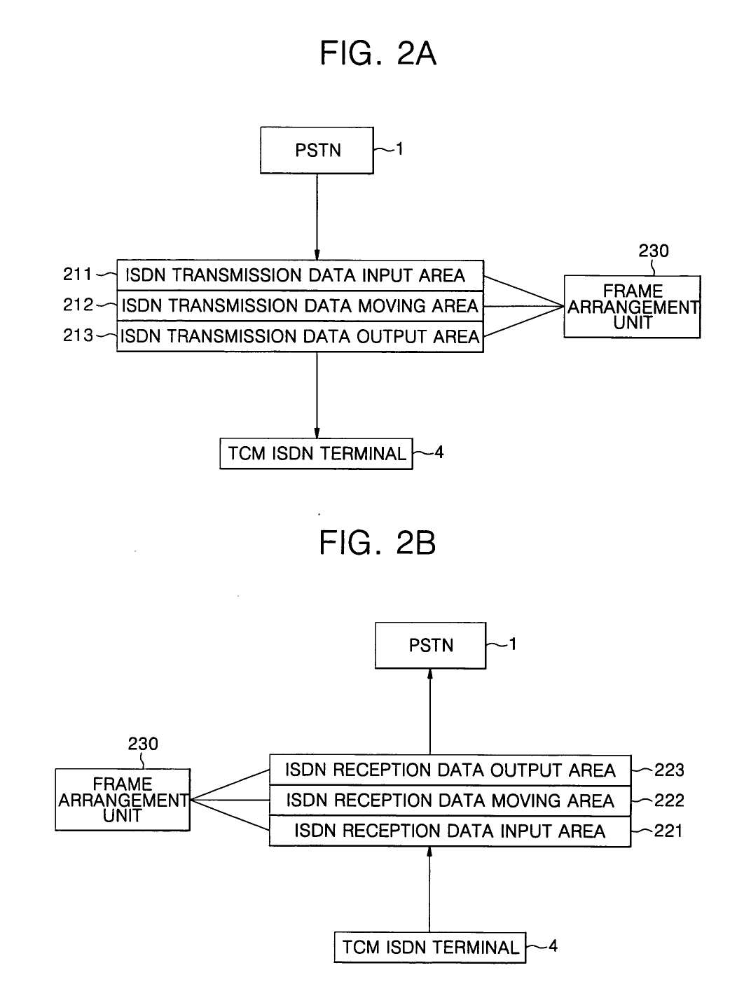

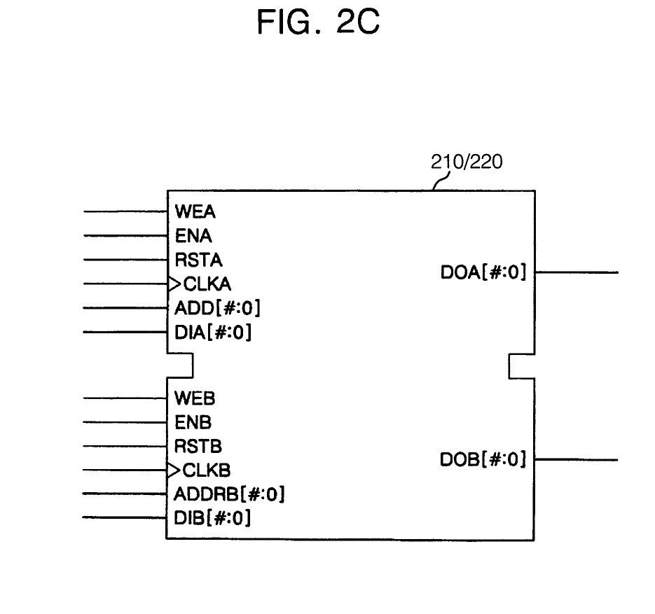

In other words, as shown in FIG. 2A, the transmission storage unit 210 includes an ISDN transmission data input area 211 for storing the input TCM ISDN data, and an ISDN transmission data output area 213 for outputting the stored TCM ISDN data. The transmission storage unit 210 further includes an ISDN transmission data moving area 212 for moving the TCM ISDN data from the ISDN transmission data input area 211 to the ISDN transmission data output area 213.

The reception storage unit 220 of the TCM ISDN subscriber processor 200 temporarily stores the TCM ISDN data received from the TCM ISDN terminal 4. The reception storage unit 220 has a capacity of 128 bytes, and has three storage areas set in a unit of 32 bytes.

In other words, as shown in FIG. 2B, the reception storage unit 220 includes an ISDN reception data input area 221 for storing the input TCM ISDN data, and an ISDN reception data output area 223 for outputting the stored TCM ISDN data. The reception storage unit 220 further includes an ISDN reception data moving area 222 for moving the TCM ISDN data from the ISDN reception data input area 221 to the ISDN reception data output area 223.

Upon receipt of the TCM ISDN data from the PSTN 1, the frame arrangement unit 230 of the TCM ISDN subscriber processor 200 temporarily stores the received TCM ISDN data in the transmission storage unit 210, synchronizes the stored TCM ISDN data to the TTR reference clock (400 Hz) provided through the synchronous clock generator 100, and transmits the synchronized TCM ISDN data to the TCM ISDN subscriber. Meanwhile, upon receipt of the TCM ISDN data from the TCM ISDN terminal 4, the frame arrangement unit 230 synchronizes the TCM ISDN data to the TTR reference clock (400 Hz) provided through the synchronous clock generator 100, temporarily stores the synchronized TCM ISDN data, and transmits the stored TCM ISDN data to the PSTN 1. In an exemplary embodiment, the frame arrangement unit 230 is to be installed between the E1 line interface and the TCM ISDN digital front end unit, not shown in the drawings.

A description of general functions and detailed operations of the constituent elements will be omitted, and operations thereof associated with the present invention will be mainly described.

First, the next generation network system includes the TCM ISDN subscriber processor 200 connecting with the PSTN 1 and transmitting and receiving the TCM ISDN data in synchronization with the TTR reference clock (400 Hz) provided from the synchronous clock generator 100; the MDSLAM 300 connecting with the ATM network 2 and transmitting/receiving the xDSL data in synchronization with the TTR reference clock (400 Hz) provided from the synchronous clock generator 100; and the synchronous clock generator 100 for receiving the broadband clock (64 KHz) from the ATM network 2 and then providing the TTR reference clock (400 Hz) and the xDSL data synchronous clock (8 KHz) to the MDSLAM 300 and at the same time, providing the TTR reference clock (400 Mz) for processing the TCM ISDN data to the TCM ISDN subscriber processor 200. In other words, in order to employ the TCM ISDN technique, the next generation network system provides the TTR reference clock (400 Hz) to the TCM ISDN subscriber processor 200 and the MDSLAM 300.

Accordingly, the clock processor 110 of the synchronous clock generator 100 generates and provides the xDSL data synchronous clock (8 KHz) and the TTR reference clock (400 Hz) to the phase locked loop 120 of the synchronous clock generator 100 using the broadband clock (64 KHz) provided from the ATM network 2. The clock processor 110 provides the TTR reference clock (400 Hz) to the TCM ISDN subscriber processor 200 and the MDSLAM 300.

After that, the phase locked loop 120 transmits the TCM ISDN data clock (2.048 MHz) and the xDSL data synchronous clock (8 KHz) to the TCM ISDN subscriber processor 200, using the broadband clock (64 KHz) received from the clock processor 110 and the divided clock (16.384 MHz) provided from the oscillator 130.

And thus, the frame arrangement unit 230 of the TCM ISDN subscriber processor 200 receives the TCM ISDN data clock (2.048 MHz) and the xDSL data synchronous clock (8 KHz) from the phase locked loop 120 and at the same time, receives the TTR reference clock (400 Hz) through the clock processor 110.

Accordingly, upon receipt of the TCM ISDN data transmitted from the PSTN 1 to the TCM ISDN terminal 4, the frame arrangement unit 230 of the TCM ISDN subscriber processor 200 temporarily stores the received TCM ISDN data in the transmission storage unit 210. The transmission storage unit 210 is divided into three areas such as the ISDN transmission data input area 211, the ISDN transmission data moving area 212, and the ISDN transmission data output area 213, and each of the areas is constituted in the unit of 32 bytes.

Accordingly, the frame arrangement unit 230 stores the TCN ISDN data received from the PSTN 1, in the unit of 32 bytes in the ISDN transmission data input area 211.

Next, the frame arrangement unit 230 shifts and moves the TCM ISDN data stored in the ISDN transmission data input area 211, to the ISDN transmission data moving area 212 and at the same time, stores TCM ISDN data of next 32 bytes in the ISDN transmission data input area 211.

After that, the frame arrangement unit 230 shifts and moves the TCM ISDN data stored in the ISDN transmission data moving area 212, to the ISDN transmission data output area 213 and at the same time, shifts and moves the TCM ISDN data stored in the ISDN transmission data input area 211, to the ISDN transmission data moving area 212.

After that, the frame arrangement unit 230 stores the TCM ISDN data in the ISDN transmission data input area 211.

Next, in case where the TCM ISDN data is stored in the ISDN transmission data output area 213, the frame arrangement unit 230 transmits the stored TCM ISDN data to the TCM ISDN terminal 4. In this case, the frame arrangement unit 230 transmits the TCM ISDN data using the TCM ISDN data clock (2.048 MHz) provided from the phase locked loop 120, and transmits the TCM ISDN data in synchronization with the TTR reference clock (400 Hz) provided from the clock processor 110.

After that, the frame arrangement unit 230 shifts the TCM ISDN data stored in the ISDN transmission data input area 211 and the ISDN transmission data moving area 212, respectively, and moves the shifted TCM ISDN data to a next area, that is, to the ISDN transmission data output area 213 and the ISDN transmission data moving area 212.

The frame arrangement unit 230 stores the TCM ISDN data to be transmitted to the TCM ISDN terminal 4, in the ISDN transmission data input area 211.

As described above, the frame arrangement unit 230 stores the TCM ISDN data received from the PSTN 1, only in the ISDN transmission data input area 211 of the transmission storage unit 210 and, for output, reads only the TCM ISDN data stored in the ISDN transmission data output area 213 of the transmission storage unit 210 and transmits the read TCM ISDN data to the TCM ISDN terminal 4 in synchronization with the TTR reference clock, thereby avoiding collision with the TCM ISDN data and in addition, performs transmission/reception in synchronization with the TTR reference clock (400 Hz), thereby embodying a TCM technique.

Meanwhile, upon receipt of the TCM ISDN data from the TCM ISDN terminal 4, the frame arrangement unit 230 stores the TCM ISDN data in the reception storage unit 220 in a unit of 32 bytes. The reception storage unit 220 is divided into three areas such as an ISDN reception data input area 221, an ISDN reception data moving area 222, and an ISDN reception data output area 223, and each of the areas is constituted in the unit of 32 bytes.

Accordingly, the frame arrangement unit 230 temporarily stores the TCM ISDN data in the unit of 32 bytes in the ISDN reception data input area 221, in synchronization with the TTR reference clock (400 Hz) provided from the clock processor 110.

After that, the frame arrangement unit 230 shifts and moves the TCM ISDN data stored in the ISDN reception data input area 221, to the ISDN reception data moving area 222 and at the same time, stores next TCM ISDN data in the ISDN reception data input area 221.

Again, the frame arrangement unit 230 moves the TCM ISDN data stored in the ISDN reception data moving area 222 and the ISDN reception data input area 221, respectively, to the ISDN reception data output area 223 and the ISDN reception data moving area 222, and then stores the TCM ISDN data in the ISDN reception data input area 221.

After that, the frame arrangement unit 230 transmits the TCM ISDN data stored in the ISDN reception data output area 223, to the PSTN 1.

As described above, the frame arrangement unit 230 synchronizes the TCM ISDN data received from the TCM ISDN terminal 4, to the TTR reference clock (400 Hz), and stores the synchronized TCM ISDN data only in the ISDN reception data input area 221 of the reception storage unit 220 and, for output, reads and transmits only the TCM ISDN data stored in the ISDN reception data output area 223 of the reception storage unit 220, to the TCM ISDN terminal 4, thereby avoiding collision of the TCM ISDN data and in addition, transmits/receives the TCM ISDN data in synchronization with the TTR reference clock (400 Hz), thereby embodying the TCM technique.

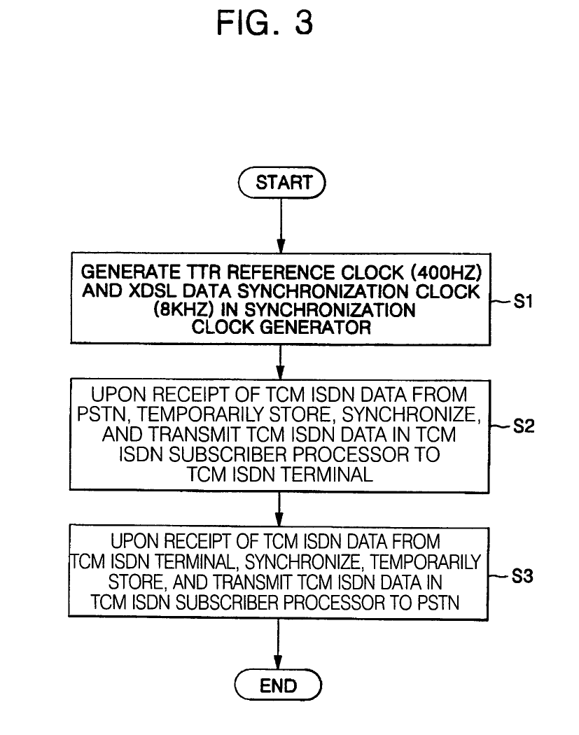

And thus, a next generation network system control method based on the TCM ISDN technique according to the present invention will be described with reference to FIG. 3.

First, in step S1 of FIG. 3, the synchronous clock generator 100 generates and provides the TTR reference clock (400 Hz) and the xDSL data synchronous clock (8 KHz) using the broadband clock (64 KHz) provided from the ATM network 2.

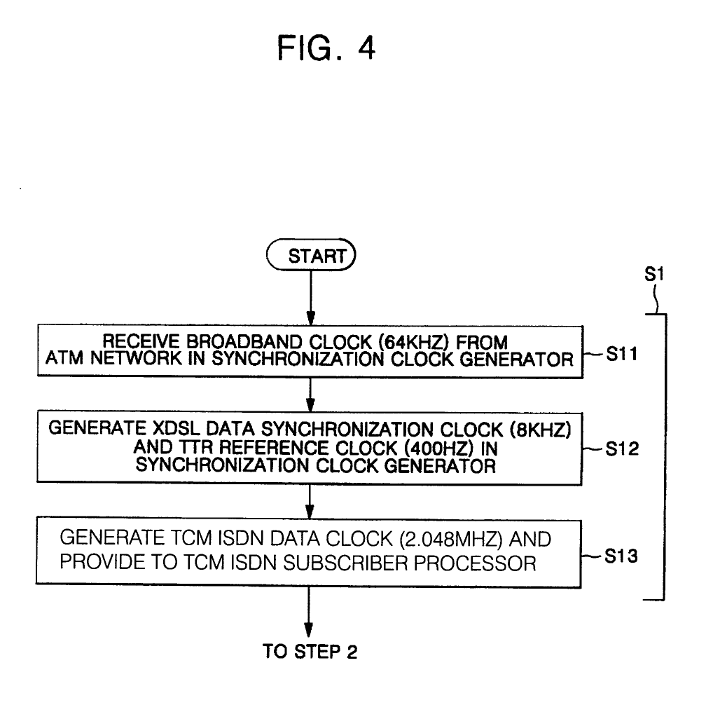

The step S1 of generating the TTR reference clock (400 Hz) and the xDSL data synchronous clock (8 KHz) using the broadband clock (64 KHz) provided from the ATM network 2 will now be described with reference to FIG. 4.

First, the synchronous clock generator 100 of switching center 3 receives the broadband clock (64 KHz) from the ATM network 2 (S11).

And thus, the synchronous clock generator 100 generates the xDSL data synchronous clock (8 KHz) and the TTR reference clock (400 Hz) using the received broadband clock (64 KHz) (S12).

Next, the synchronous clock generator 100 generates and provides the TCM ISDN data clock (2.048 MHz) to the TCM ISDN subscriber processor 200, using the generated xDSL data synchronous clock (8 KHz) and TTR reference clock (400 Hz), and the divided clock (16.38 MHz) provided from the oscillator 130 (S13).

After that, as shown in is step S2 of FIG. 3, upon receipt of the TCM ISDN data from the PSTN 1, the TCM ISDN subscriber processor 200 of switching center 3, receiving the xDSL data synchronous clock (8 KHz), the TTR reference clock (400 Hz), and the TCM ISDN data clock (2.048 MHz) through the synchronous clock generator 100, temporarily stores the received TCM ISDN data, synchronizes the stored TCM ISDN data to the TTR reference clock (400 Hz) and the xDSL data synchronous clock (8 KHz), and transmits the synchronized TCM ISDN data to the TCM ISDN terminal 4.

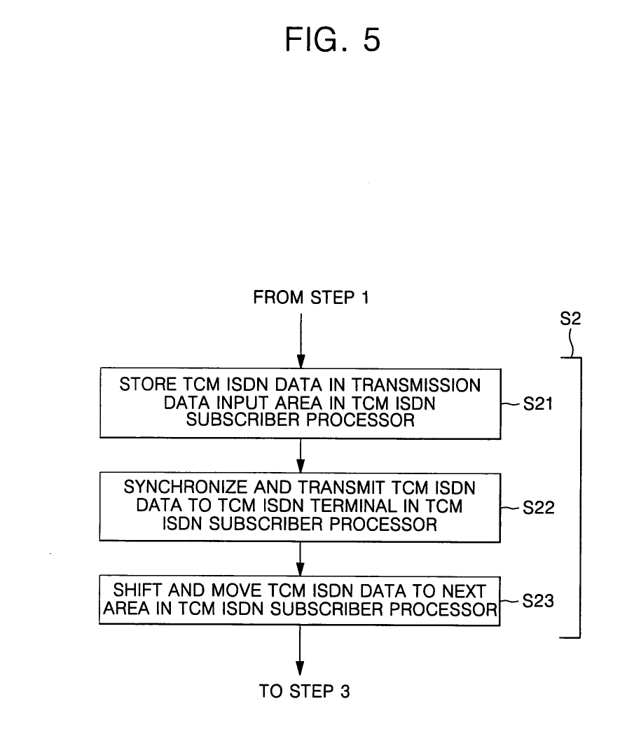

The step (S2) of temporarily storing the received TCM ISDN data, upon receipt of the TCM ISDN data from the PSTN 1, and transmitting the stored TCM ISDN data to the TCM ISDN terminal 4 in synchronization with the TTR reference clock (400 Hz) and the xDSL data synchronous clock (8 KHz) will now be described in detail with reference to FIG. 5.

First, the TCM ISDN subscriber processor 200 stores the TCM ISDN data received from the PSTN 1, in the ISDN transmission data input area 211 (S21).

After that, the TCM ISDN subscriber processor 200 synchronizes the TCM ISDN data stored in the ISDN transmission data output area 213, to the TTR reference clock (400 Hz) and the xDSL data synchronous clock (8 KHz), and transmits the synchronized TCM ISDN data to the TCM ISDN terminal 4 (S22).

After transmitting the TCM ISDN data synchronized to the TTR reference clock (400 Hz) and the xDSL data synchronous clock (8 KHz), the TCM ISDN subscriber processor 200 shifts and moves the TCM ISDN data stored in each area to respective next areas (S23).

On contrary, as shown in step S3 of FIG. 3, upon receipt of the TCM ISDN data from the TCM ISDN terminal 4, the TCM ISDN subscriber processor 200 temporarily stores the received TCM ISDN data in synchronization with the TTR reference clock (400 Hz) and the xDSL data synchronous clock (8 KHz), and transmits the stored TCM ISDN data to the PSTN 1.

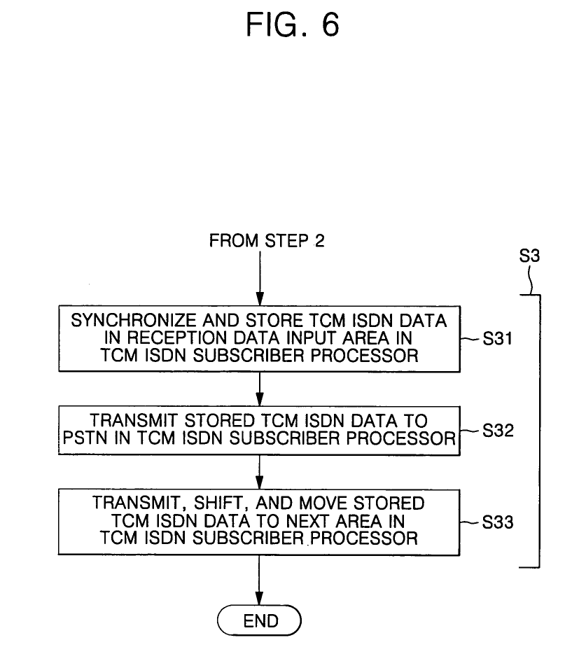

The step (S3) of, upon receipt of the TCM ISDN data from the TCM ISDN terminal 4, temporarily storing the received TCM ISDN data in synchronization with the TTR reference clock (400 Hz), and transmitting the stored TCM ISDN data to the PSTN 1 will now be described with reference to FIG. 6.

First, the TCM ISDN subscriber processor 200 synchronizes the TCM ISDN data received from the TCM ISDN terminal 4, to the TTR reference clock (400 Hz) and the xDSL data synchronous clock (8 KHz), and stores the synchronized TCM ISDN data in the ISDN reception data input area 221 (S31).

Next, the TCM ISDN subscriber processor 200 transmits the TCM ISDN data stored in the ISDN reception data output area 223, to the PSTN 1 (S32).

The TCM ISDN subscriber processor 200 transmits the TCM ISDN data that is stored in synchronization with the TTR reference clock as above, to the PSTN 1 and then, shifts and moves the TCM ISDN data stored in each area, to respective next areas (S33).

At this time, the TCM ISDN subscriber processor 200 performs a processing procedure below.

As shown in FIG. 2C, the transmission/reception storage unit (210/220) has terminals WEA, ENA, RSTA, CLKA, ADD[#:0], DIA[#:0], and DOA[#:0], and WEB, ENB, RSTB, CLKB, ADDRB[#:0], DIB[#:0], and DOB[#:0].

A processing procedure for storing the data in the ISDN transmission data input area 211 or the ISDN reception data input area 221 is shown below.

```
LIBRARY ieee;
USE ieee.std_logic_1164.ALL;
Library XilinxCoreLib;
ENTITY bmdpram_512 IS
  port (
  addra: IN std_logic_VECTOR(6 downto 0);
  addrb: IN std_logic_VECTOR(6 downto 0);
  clka: IN std_logic;
  clkb: IN std_logic;
  dina: IN std_logic_VECTOR(7 downto 0);
  doutb: OUT std_logic_VECTOR(7 downto 0);
  enb: IN std_logic;
  wea: IN std_logic);
END bmdpram_512;
```

A processing procedure of storing the data in the ISDN transmission data output area 213 and the ISDN reception data output area 223 is shown below.

```
process(Xrstb, DownRd_Clk, DownBSync)
begin
  if(Xrstb = ‘0’) then
      xrxdpr_enb <= ‘0’;
      xrxdpr_rcnt(7 downto 0) <= “00000000”;
      xrxdpr_radr <= (others => ‘0’);
      xrxframe_addr <= “00”;
  elsif (DownRd_Clk'event and DownRd_Clk = ‘0’) then
    if (DownBSync = ‘0’) then
      xrxdpr_rcnt(7 downto 0) <= “00000001”;
      xrxframe_addr <= xframe_addr + “10”;
      xrxdpr_radr <= xrxframe_addr & “00010”;
      xrxdpr_enb <= ‘0’;
    elsif(xrxdpr_rcnt(2 downto 0) = “111”) then
      xrxdpr_radr <= xrxdpr_radr + ‘1’;
      xrxdpr_enb <= ‘1’;
      xrxdpr_rcnt <= xrxdpr_rcnt + ‘1’;
    else
      xrxdpr_enb <= ‘0’;
      xrxdpr_rcnt <= xrxdpr_rent + ‘1’;
    end if;
  end if;
end process;
```

A processing procedure of storing the data in the ISDN transmission data moving area 212 and the ISDN reception data moving area 222 is shown below.

```
FPGARX_PtoS1: process(Xrstb, DownRd_Clk,xrxdpr_enb)
begin
  if(Xrstb = ‘0’) then
      xreg2 <= “11111111”;
  elsif(DownRd_Clk'event and DownRd_Clk=‘1’) then
    if (xrxdpr_enb = ‘1’) then
      xreg2 <= xrxdpr_dout;
    else
  xreg2 <= xreg2(6 downto 0) & ‘1’;
    end if;
  end if;
end process FPGARX_PtoS1;
DownData_Out <= xreg2(7);
end Behaviral_arch;
```

As described above, the next generation network system and the control method thereof based on the TCM ISDN technique according to the present invention have an effect in that, when a TCM ISDN service and an xDSL service are concurrently provided, noise generated at the time of bundling the data service line is eliminated, thereby providing a stable system.

While the present invention has been described with reference to exemplary embodiments thereof, it will be understood by those skilled in the art that various changes in from and detail may be made therein without departing from the scope of the present invention as defined by the following claims.

What is claimed is:

1. A next generation network system based on a time compression multiplex (TCM) integrated service digital network (ISDN) technique, in which a TCM ISDN (time compression multiplex integrated service digital network) service and an x digital subscriber line (xDSL) service are integrated, the system comprising:
a synchronous clock generator for generating a transmit timing reference (TTR) reference clock to be used in a time compression multiplex integrated service digital network and an xDSL, using a broadband clock provided through an asynchronous transfer mode (ATM) network; and
a time compression multiplex integrated service digital network subscriber processor for temporarily storing time compression multiplex integrated service digital network data received from a public switched telephone network (PSTN), arranging a frame of the time compression multiplex integrated service digital network data, synchronizing the time compression multiplex integrated service digital network data to the TTR reference clock provided from the synchronous clock generator, and transmitting the synchronized time compression multiplex integrated service digital network data to a time compression multiplex integrated service digital network subscriber while, synchronizing the time compression multiplex integrated service digital network data received from a time compression multiplex integrated service digital network terminal, to the TTR reference clock input from the synchronous clock generator, temporarily storing the synchronized time compression multiplex integrated service digital network data, and transmitting the stored time compression multiplex integrated service digital network data to the public switched telephone network.

2. The system of claim 1, wherein the synchronous clock generator comprises:
a clock processor for generating an xDSL data synchronization clock and a TTR reference clock using the broadband clock provided from the asynchronous transfer mode network; and
a phase locked loop for providing a time compression multiplex integrated service digital network data clock to the time compression multiplex integrated service digital network subscriber processor, using the xDSL data synchronization clock and the TTR reference clock provided from the clock processor and a divided clock provided from an oscillator.

3. The system of claim 1, wherein the broadband clock received from the asynchronous transfer mode network is a DCS clock of 64 KHz.

4. The system of claim 2, wherein the time compression multiplex integrated service digital network data clock provided from the phase locked loop is a clock of 2.049 KHz.

5. The system of claim 1, wherein the time compression multiplex integrated service digital network subscriber processor comprises:
a transmission storage unit for temporarily storing the time compression multiplex integrated service digital network data input from the public switched telephone network;
a reception storage unit for temporarily storing the time compression multiplex integrated service digital network data received from the time compression multiplex integrated service digital network terminal; and
a frame arrangement unit for, upon receipt of the time compression multiplex integrated service digital network data from the public switched telephone network, temporarily storing the received time compression multiplex integrated service digital network data in the transmission storage unit, synchronizing the stored time compression multiplex integrated service digital network data to the TTR reference clock provided from the synchronization clock generator, and transmitting the synchronized time compression multiplex integrated service digital network data to the time compression multiplex integrated service digital network subscriber while, upon receipt of the time compression multiplex integrated service digital network data from the time compression multiplex integrated service digital network terminal, synchronizing the received time compression multiplex integrated service digital network data to the TTR reference clock provided from the synchronization clock generator, temporarily storing the synchronized time compression multiplex integrated service digital network data, and transmitting the stored time compression multiplex integrated service digital network data to the public switched telephone network.

6. The system of claim 5, wherein the transmission storage unit comprises:
an ISDN transmission data input area for storing the input data; and
an ISDN transmission data output area for outputting the stored data.

7. The system of claim 6, wherein the transmission storage unit includes three storage areas set in a unit of 32 bytes.

8. The system of claim 5, wherein the reception storage unit has a capacity of 128 bytes.

9. The system of claim 8, wherein the reception storage unit comprises:
an ISDN reception data input area for storing the input data; and
an ISDN reception data output area for outputting the stored data.

10. The system of claim 9, wherein the reception storage unit further comprises an ISDN reception data moving area for moving the data from the ISDN reception data input area to the ISDN reception data output area.

11. The system of claim 10, wherein the reception storage unit comprises three storage areas set in a unit of 32 bytes.

12. A next generation network system control method based on a time compression multiplex (TCM) integrated service digital network (ISDN) technique, for frame synchronization in a next generation network system that can process a time compression multiplex integrated service digital network and an x digital subscriber line (xDSL), the method comprising the steps of:
generating, by a synchronization clock generator, a transmit timing reference (TTR) reference clock and an xDSL data synchronization clock, using a broadband clock provided from an asynchronous transfer mode (ATM) network; and
upon receipt of time compression multiplex integrated service digital network data from a public switched telephone network (PSTN), temporarily storing, by a time compression multiplex integrated service digital network subscriber processor, the received time compression multiplex integrated service digital network data, synchronizing the stored time compression multiplex integrated service digital network data to the TTR reference clock and the xDSL data synchronous clock, and transmitting the synchronized time compression multiplex integrated service digital network data to a time compression multiplex integrated service digital network subscriber.

13. The method of claim 12, wherein the step of generating, by the synchronization clock generator, the TTR reference clock and the xDSL data synchronization clock, using the broadband clock provided from the asynchronous transfer mode network, comprises the steps of:
receiving, by the synchronization clock generator, the broadband clock from the asynchronous transfer mode network;
generating, by the synchronization clock generator, the xDSL data synchronization clock and the TTR reference clock, using the received broadband clock; and
generating, by the synchronization clock generator, a time compression multiplex integrated service digital network data clock using the generated xDSL data synchronization clock and TTR reference clock, and a divided clock provided from an oscillator, and providing the generated time compression multiplex integrated service digital network data clock to the time compression multiplex integrated service digital network subscriber processor.

14. The method of claim 13, wherein the time compression multiplex integrated service digital network data clock is a clock of 2.049 KHz.

15. The method of claim 12, wherein the step of, upon receipt of the time compression multiplex integrated service digital network data from the public switched telephone network, temporarily storing, by the time compression multiplex integrated service digital network subscriber processor, the received time compression multiplex integrated service digital network data, synchronizing the stored time compression multiplex integrated service digital network data to the TTR reference clock and the xDSL data synchronization clock, and transmitting the synchronized time compression multiplex integrated service digital network data to the time compression multiplex integrated service digital network subscriber, comprises the steps of:
storing, by the time compression multiplex integrated service digital network subscriber processor, the time compression multiplex integrated service digital network data received from the public switched telephone network, in an ISDN transmission data input area; and
synchronizing, by the time compression multiplex integrated service digital network subscriber processor, the time compression multiplex integrated service digital network data stored in an ISDN transmission data output area, to the TTR reference clock, and transmitting the synchronized time compression multiplex integrated service digital network data to a time compression multiplex integrated service digital network terminal.

16. The method of claim 15, wherein in the step of, upon receipt of the time compression multiplex integrated service digital network data from the public switched telephone network, temporarily storing, by the time compression multiplex integrated service digital network subscriber processor, the received time compression multiplex integrated service digital network data, synchronizing the stored time compression multiplex integrated service digital network data to the TTR reference clock and the xDSL data synchronization clock, and transmitting the synchronized time compression multiplex integrated service digital network data to the time compression multiplex integrated service digital network subscriber, after the time compression multiplex integrated service digital network data is transmitted in synchronization with the TTR reference clock, the time compression multiplex integrated service digital network data stored in each area is shifted and moved to a next area.

17. The method of claim 12, further comprising the step of, upon receipt of the time compression multiplex integrated service digital network data from a time compression multiplex integrated service digital network terminal, synchronizing, by the time compression multiplex integrated service digital network subscriber processor, the received time compression multiplex integrated service digital network data to the TTR reference clock and the xDSL data synchronization clock, temporarily storing the synchronized time compression multiplex integrated service digital network data, and transmitting the stored time compression multiplex integrated service digital network data to the public switched telephone network.

18. The method of claim 17, wherein the step of, upon receipt of the time compression multiplex integrated service digital network data from the time compression multiplex integrated service digital network terminal, synchronizing, by the time compression multiplex integrated service digital network subscriber processor, the received time compression multiplex integrated service digital network data to the TTR reference clock and the xDSL data synchronization clock, temporarily storing the synchronized time compression multiplex integrated service digital network data, and transmitting the stored time compression multiplex integrated service digital network data to the public switched telephone network, comprises the steps of:
synchronizing, by the time compression multiplex integrated service digital network subscriber processor, the time compression multiplex integrated service digital network data received from the time compression multiplex integrated service digital network terminal, to the TTR reference clock, and storing the synchronized time compression multiplex integrated service digital network data in an ISDN reception data input area; and
transmitting, by the time compression multiplex integrated service digital network subscriber processor, the time compression multiplex integrated service digital network data stored in an ISDN reception data output area, to the public switched telephone network.

19. The method of claim 18, wherein in the step of, upon receipt of the time compression multiplex integrated service digital network data from the time compression multiplex integrated service digital network terminal, synchronizing, by the time compression multiplex integrated service digital network subscriber processor, the received time compression multiplex integrated service digital network data to the TTR reference clock and the xDSL data synchronization clock, temporarily storing the synchronized time compression multiplex integrated service digital network data, and transmitting the stored time compression multiplex integrated service digital network data to the public switched telephone network, after transmitting the time compression multiplex integrated service digital network data stored in synchronization with the TTR reference clock, to the public switched telephone network, the time compression multiplex integrated service digital network subscriber processor shifts and moves the time compression multiplex integrated service digital network data stored in each area, to a next area.
